(19) United States
(12) Patent Application Publication
(10) Pub. No.: US 2014/0149887 A1
(43) Pub. Date: May 29, 2014

(54) METHODS AND SYSTEMS FOR PROVIDING CUSTOMIZED RESOLUTION IN RESPONSE TO USERS' OBJECTION TO POSTED CONTENT

(71) Applicant: Facebook, Inc., Menlo Park, CA (US)

(72) Inventors: Arturo Bejar, Saratoga, CA (US); Dacher Keltner, Berkeley, CA (US); Paul Piff, Oakland, CA (US); Emiliana Simon-Thomas, Berkeley, CA (US)

(21) Appl. No.: 13/689,395

(22) Filed: Nov. 29, 2012

(51) Int. Cl. G06F 3/0484

(52) U.S. Cl. CPC G06F 3/0484
USPC 715/753

(57) ABSTRACT

A social networking service initiates a custom resolution process when a receiving user indicates objection to a message posted by a posting user. In embodiments, the networking service provides interfaces to the receiving user to obtain information about the user's intended goal, and to elicit information from the user about the context of the user's objection. The networking service analyzes the received information to determine an emotional context associated with the objection. Based on the emotional context and also based on additional social context information associated with the two users, the networking service presents customized resolution options to the receiving user.

### TECHNICAL FIELD

This invention relates generally to social networking, and in particular to providing customized resolution options to assist a user in resolving objections the user may have to content posted via a social networking platform.

### BACKGROUND

In recent years, users of social networking platforms have shared their interests and engaged with other users of the social networking systems by sharing photos, real-time status updates, playing social games, etc. The users typically post interactions (e.g., updates, messages to specific users, pictures, etc.) relating to a variety of activities, including, for example, recent moves to a new city, graduations, births, engagements, marriages, and the like, as well as more mundane content such as status messages, information about what music has been listened to by users, and recent check-in events at coffee shops.

Recent social networking phenomenon includes the concept of “tagging,” where a user tags other users in various interactions. For example, in an interaction involving a picture posted on the user's wall (or other such status or news information page associated with the user's profile in the social networking platform), the user may tag one or more friends that are in the picture. Based on privacy settings, such an interaction may cause the image and the associated tagging to be visible to all of the user's connections as well as the connections of the tagged friends. A tagged friend may object to the picture for a variety of reasons (e.g., the friend does not look good in the picture, the friend does not want other people to know that he was at the location captured in the picture, etc.). If the tagged friend does not wish to be tagged in the picture or otherwise be associated with the posted picture in the social networking platform, he would typically have to place a request via the networking platform to get untagged. While such a solution gets the job done (i.e., the user is untagged), the solution is not aimed at promoting greater understanding or resolving any conflicts between the original user and the user that is tagged.

A similar problem exists even outside of the above context where a user objects to being tagged in a picture or a message. Some users, for example, by virtue of being connected as “friends” to certain unsavory users, may receive updates or interactions submitted by such users that may be considered objectionable. Such interactions may be objectionable for a variety of reasons, both objective (e.g., the interaction includes pornographic images, the interaction includes graphically violent images, etc.) and subjective (e.g., the interaction includes a message that disparages a good friend, etc.). In such situations, the objecting user can only simply either block the offensive user or report the interaction to the social networking platform. Again, such solutions are not aimed at promoting greater understanding or resolving the underlying conflict and do not present adequate resolution options to the objecting user.

### SUMMARY

Techniques introduced herein include providing customized resolution options to users that object to certain interactions or messages posted by other users within a social networking platform. In one embodiment, a social networking service (simply, “networking service”) operated by the social networking platform initiates a custom resolution process when a receiving user (i.e., a user that receives a message) indicates objection to or displeasure with a message or an interaction posted by a posting user (i.e., a user that posts the message received by the receiving user). In embodiments, the networking service provides interfaces to the receiving user to obtain information about the user's intended goal (e.g., untag the receiving user, block the posting user, report the posted interaction to the networking service, etc.). The networking service uses the interfaces to further elicit information from the user about the context of the user's objection.

In embodiments, the networking service analyzes the received information to determine an emotional context associated with the receiving user's objection. In some instances, the networking service may also determine social context between the two users (e.g., what is the relationship between the users, how often do the users communicate with each other, what common interests do they have, etc.). Based on such collected information and the determined emotional and social context, the networking service presents customized resolution options. As is further explained in the detailed description, such customized resolution options are catered toward generating greater understanding and resolving conflicts between the users, improving effectiveness of communication between the users, providing choices to the receiving user to help the user make a suitable decision for responding to the objection, etc.

### BRIEF DESCRIPTION OF THE DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 provides a brief, general description of a representative environment in which the invention can be implemented;

FIG. 2A is a flow diagram depicting a process for providing customized resolution options in response to a receiving user disapproval of an interaction or a message submitted by a posting user;

FIG. 2B provides examples of various customized resolution options;

FIG. 3 depicts a process that focuses on customized resolution options provided specifically in a situation where a receiving user wishes to untag his identity from an image or other such message;

FIGS. 4A-4D are screenshots that illustrate an exemplary functioning of the customized resolution process described herein; and

FIG. 5 is a high-level block diagram showing an example of the architecture for a computer system.

The headings provided herein are for convenience only and do not necessarily affect the scope or meaning of the claimed invention.

### DETAILED DESCRIPTION

### Overview

A social networking platform offers its users the ability to communicate and interact with other users of the social networking system. Users join the social networking platform and add connections to a number of other users to whom they desire to be connected. Users of the social networking platform can provide information about themselves, which is stored as user profiles. For example, users can provide their age, gender, geographical location, education history, employment history and the like. The information provided by users may be used by the social networking system to direct information to the user. For example, the social networking platform may recommend social groups, events, and potential friends to a user.

In addition to declarative information provided by users, social networking systems may also record, subject to any privacy policies and/or settings, users' actions or interactions on the social networking platform. These actions or interactions include communications with other users (e.g., posting a message on a user's public or private information section; also called a user's “wall” section), sharing images (e.g., photos, videos), associating (also called “tagging”) a shared picture with the identities of one or more users of the social networking platform, interactions with applications that operate on the social networking platform, such as a social gaming application, responding to a poll, adding an interest, and joining an employee network, etc.

In many instances, as briefly indicated above, the interactions result in a first user (a “posting user”) recording or otherwise submitting an interaction (e.g., a sharing of a photo, posting a message on the user's profile section, etc.) that directly or indirectly associates a different user (a “receiving user”). Such an association may be imparted in a variety of manners. For example, the posting user may specifically “tag” the receiving user or a friend of the receiving user as being part of a posted image or an informational message. In exemplary instances, this may cause the receiving user to receive an alert that the posting user has submitted information relating to the receiving user. In some instances, the alert may be in the form of an email or a text message sent to the receiving user.

In some instances, the alert may be in the form of a message posted to the user's wall section indicating that the receiving user has been associated with an interaction from the posting user. In some instances, the social networking platform may post the interaction itself to the user's wall section as a measure of both alerting the receiving user to the interaction and also providing the receiving user the actual interaction. In some instances, the receiving user may simply be “subscribed” to the posting user. Subscribed, as referred to herein, may indicate a situation where the receiving user has previously established a social connection with the posting user via the social networking platform, and by virtue of this connection, receives updates or indications of any of (or a selected subset of) the posting user's interactions via the social networking platform.

In any of these instances, the receiving user may disapprove of the interaction itself or of being associated with an interaction. In a typical example, the receiving user may object to being tagged in an image posted by the posting user. The receiving user, for example, may not like the way he or she looks in the picture, or may not wish for other users (e.g., social connections of the posting user or the receiving user) to view such an image. In another example, the receiving user may simply not be in the picture and may have been incorrectly tagged. In a further example, even if the user is not tagged or otherwise specifically associated with the image, the receiving user may still consider the image objectionable for a wide variety of reasons.

The receiving user could find the image objectionable on the basis of, for example, the image being of pornographic nature, the image being intended to initiate violence or aggression by other users, the image being in the nature of a spam or scam, the image depicting graphic violence, the image depicting or suggesting an illegal activity (e.g., use of illegal drugs), the image simply being of a type that is not typical to be posted by the posting user (e.g., in a situation where the receiving user suspects that the posting user's account may have been compromised or hacked by another user), etc. While these examples are from the perspective of images posted by the posting user, the same reasons for disapproval may apply to all other interactions submitted by the posting user.

In typical instances, the receiving user may express such disapproval of the interaction in one of several manners. For example, the receiving user may simply request that the receiving user be untagged (or otherwise disassociated) from the posted interaction. In another example, the receiving user may initiate a “reporting” action to report to the social networking platform of the unacceptable nature of the posted interaction. In another example, the receiving user may request the social networking platform to “block” or “unsubscribe” the posting user. If the posting user is blocked, the posting user is typically cut off from all communication with the receiving user (and vice versa) within the social networking platform. The posting user may also be removed as a social connection from the receiving user's profile. On the other hand, if the posting user is unsubscribed, the social connection may still be maintained, but any interactions submitted by the posting user are made available for viewing by the receiving user. In a way, the receiving user simply ignores interactions submitted by the receiving user.

In typical scenarios, where the user has expressed displeasure in an interaction submitted by the receiving user, the traditional techniques used by social networking platforms simply execute that particular mode without much follow-up or opportunities for reporting. These networking services have not historically offered any customized solutions or options that may further improve the effectiveness of communication for better understanding between the users and improve the efficiency of the conflict resolution process. For example, when the receiving user selects the untag mode to disassociate herself from an interaction, the receiving user simply gets untagged without having an opportunity to perform other functions (e.g., communicate with the other user by sending a message to the other user, report the action, etc.) that may help in resolving the disapproval or underlying conflict.

A more customized resolution of underlying issues to the disapproval may resolve communication issues between the receiving user and the posting user, potentially resulting in enhanced future communication opportunities. From the social networking platform's perspective, promoting understanding, resolving conflict or issues between users and enhancing communication opportunities is a better alternative to more severe alternatives that hinder communication (such as when the user simply decides to block the user). In illustrative instances, meaningful social reporting (e.g., to the posting user) of issues foster growth of communication between users. Social reporting may be in the form of analyzing the context (e.g., emotional context) behind a user's indication of displeasure and providing mechanisms for efficiently conveying the displeasure to concerned users in an effort, for example, to resolve issues that are underlying to the indication of displeasure.

In other instances, such as in the case of the receiving user “reporting” the interaction of the posting user to the social networking platform, analyzing the underlying emotional or social context that prompted the reporting request may be useful in providing meaningful resolution options to the receiving user. These meaningful and customized resolution options may offer the added advantage of at least reducing the number of spurious reports (i.e., reports that do not violate the social networking platform's standards or norms) that need to be resolved by administrators of the social networking platform.

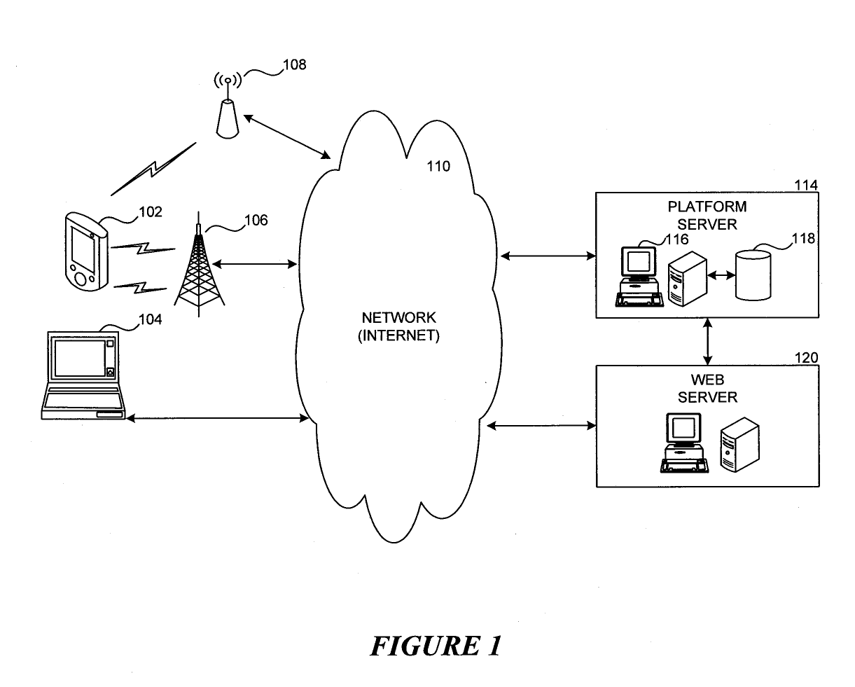

Accordingly, the techniques illustrated herein discuss improved methods and systems for dealing with social interactions and handling consequent social reporting. Specifically, and as will be discussed in detail below with the aid of FIGS. 1-5, the techniques introduced herein provide mechanisms that enable the receiving user to express discontent or displeasure over a particular interaction and also provide opportunities for customized resolution of the displeasure.

As contemplated by the techniques discussed herein, in some instances, when the user wishes to express displeasure, the user is presented with customized resolution options to promote understanding and resolve conflicts in interactions. In embodiments, these customized resolution options are provided on the basis of context inferred from the social context between the two users and/or emotional context associated with the receiving user's objection to an interaction. In one example of a customized resolution option, the receiving user is given the opportunity to perform more than one action to proceed with resolving the issue. For example, in the context of an interaction where the receiving user is tagged, the receiving user is given the opportunity to both untag herself form the interaction and also initiate a message to be sent to the posting user. The message may be for the purpose of letting the posting user know of the receiving user's emotional context behind the action and/or also request the posting user to remove the interaction from the social networking platform.

In some instances, the social networking platform collects information from the user to analyze or understand the receiving user's emotional context behind the displeasure, and utilizes this emotional context to at least partially prepopulate the message with suitable text. With this text as a starting point, the receiving user has an opportunity to draft, without spending too much time or effort, a message designed to efficiently convey the displeasure and/or remove request to the posting user. In some instances, the social networking platform may allow the receiving user to perform, either in tandem or as following steps, other actions such as reporting to the social networking platform or blocking the posting user.

It is understood, however, that the user may still perform any of the actions separately (e.g., the user may simply just send a message to the posting user without initiating an untag action or a blocking action). Even in such instances, where any type of social reporting is involved (e.g., reporting to the posting user, reporting to the social networking platform, etc.), the techniques introduced herein offer an opportunity to provide a message that is customized at least in part based on the analyzed emotional context of the receiving user.

In some instances, the social networking platform may also suggest suitable resolution options that are customized based on the analyzed context. For example, when the context indicates that the user's displeasure is because of an image showing pornographic images or images of extreme violence, the social networking platform may offer as choices an option to untag the receiving user from the image (assuming the user was tagged in the message) and also provide an option to initiate a message to report to the social networking platform.

In the context of a user initiating a reporting action to the social networking platform, the platform may analyze a true feeling of the user using several resources, including, for example, the emotional context obtained from the receiving user, the social context between the receiving user and the posting user (e.g., how long have then been “friends” in the social networking platform, what common interests they have, etc.), etc. Based on this, the social networking platform may propose customized resolution options such as, for example, connecting the receiving user with other users that have faced similar issues (who may be in a position to help the receiving user), blocking the posting user to the receiving user, taking action against the posting user for violation of the social networking platform's norm or standard, etc. Additional examples of such customized resolution options are discussed in further detail below in the discussion of the illustrative environment and architecture.

As will also be discussed in further detail below, the social networking platform may obtain and/or analyze the receiving user's emotional context using several options. In one example, the social networking platform may publish a list of queries requesting the receiving user to select responses based on their emotional state in the displeasure. In one example, the queries may be customized based on the receiving user's geographic location, social context in relation to the posting user, etc. In one example, the queries may be in the form of emoticons allowing the receiving user to provide an indication of the reason behind their displeasure. In one example, the user may be allowed to provide an image (a still picture or a video image) to the social networking platform, and the underlying emotional context may be observed by analyzing the image. In other examples, the receiving user may simply provide free text regarding her displeasure and a semantic analysis of the free text may be used to analyze the underlying emotional context.

### Illustrative Environment and Associated Description of Customized Resolution Functionalities

Various examples of the techniques introduced above will now be described in further detail. The following description provides specific details for a thorough understanding and enabling description of these examples. One skilled in the relevant art will understand, however, that the techniques discussed herein may be practiced without many of these details. Likewise, one skilled in the relevant art will also understand that the techniques can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this section.

FIG. 1 and the following discussion provide a brief, general description of a representative environment in which the techniques described herein can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

As shown in FIG. 1, a user may use a personal computing device (e.g., a phone 102, a personal computer 104, etc.) to communicate with a network. The term “phone,” as used herein, may be a personal digital assistant (PDA), a portable email device (e.g., a Blackberry®), a portable media player (e.g., an IPod Touch®), or any other device having communication capability to connect to the network. In one example, the phone 102 connects using one or more cellular transceivers or base station antennas 106 (in cellular implementations), access points, terminal adapters, routers or modems 108 (in IP-based telecommunications implementations), or combinations of the foregoing (in converged network embodiments).

In some instances, the network 110 is the Internet, allowing the phone 102 (with, for example, WiFi capability) or the personal computer 104 to access web content offered through various web servers. In some instances, especially where the phone 102 is used to access web content through the network 110 (e.g., when a 3G or an LTE service of the phone 102 is used to connect to the network 110), the network 110 may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

In some instances, a user uses one of the personal computing devices (e.g., the phone 102, the personal computer 104, etc.) to connect to a social networking platform server (simply, a “platform server”) 114 through the network 110. In one embodiment, the platform server 114 comprises a server computer 116 coupled to a local database 118. The term “platform server” as indicated herein, refers to an individual or multiple server stations or other computing apparatus. In one embodiment, the platform server additionally operates as a web server capable of hosting web pages associated with the social networking platform and storing related content (e.g., user profiles, user data, communication data, news feeds, etc.). In some embodiments, the platform server 114 is separate from a web server, but communicates with a web server to provide, manage, and/or control content generated by the web server. In general, the platform server 114 controls content provided to users via the social networking platform. As shown in FIG. 1, in some embodiments, the personal computing devices and the platform server 114 are connected through the network 110 to one or more web servers (e.g., web server 120).

In one embodiment, the platform server offers a social networking platform service (simply, the “networking service”) that operates as the basis for the techniques discussed herein. A networking service, as used herein, is an online service, platform, or site that focuses on facilitating the building of social networks or social relations among people who, for example, share interests, activities, backgrounds, or real-life connections. A networking service consists of a representation of each user (often a profile), his/her social links, and a variety of additional services. In embodiments, the networking service offered by the platform server 114 is web-based and provide means for users to interact over the Internet, such as e-mail and instant messaging. The networking service offers a variety of additional interaction options to its users. For example, a user is presented with “news walls” with information updates about various activities of other users the user is connected with through the networking service. In general, the networking service allows users to share ideas, activities, events, and interests within their individual networks.

For example, a receiving user with an associated news wall receives updates related to interactions of (or submitted by) her social connections. These interactions or indications of such interactions are posted on her news wall. In some instances, the interactions may be in the form of a text message a posting user (typically, a “friend” or a social connection of the receiving user) submits or posts on the user's news wall. In instances, such an interaction may also be viewed by other social connections or friends of the receiving user as an interaction between the posting user and the receiving user. In some instances, the interaction may just be a message the receiving user posts on his own news wall and indication of that interaction is conveyed through the news walls of the posting user's friends (which would include the receiving user). In any of these instances, an indication of the interaction is presented to the receiving user.

When an interaction is received, in some instances, the receiving user is directly tagged or otherwise associated to the message. In other instances, the message is simply viewable (or gets posted to the receiving user's news wall) but does not otherwise directly associate the receiving user. The interaction or the message (the two words may be used interchangeably here to denote information submitted by the posting user via the networking service) may include a text message, an image (video or photo) that may include textual description, a blog article (or a link to one), a geographic location indication (indicating where and with whom the posting user is currently located), etc.

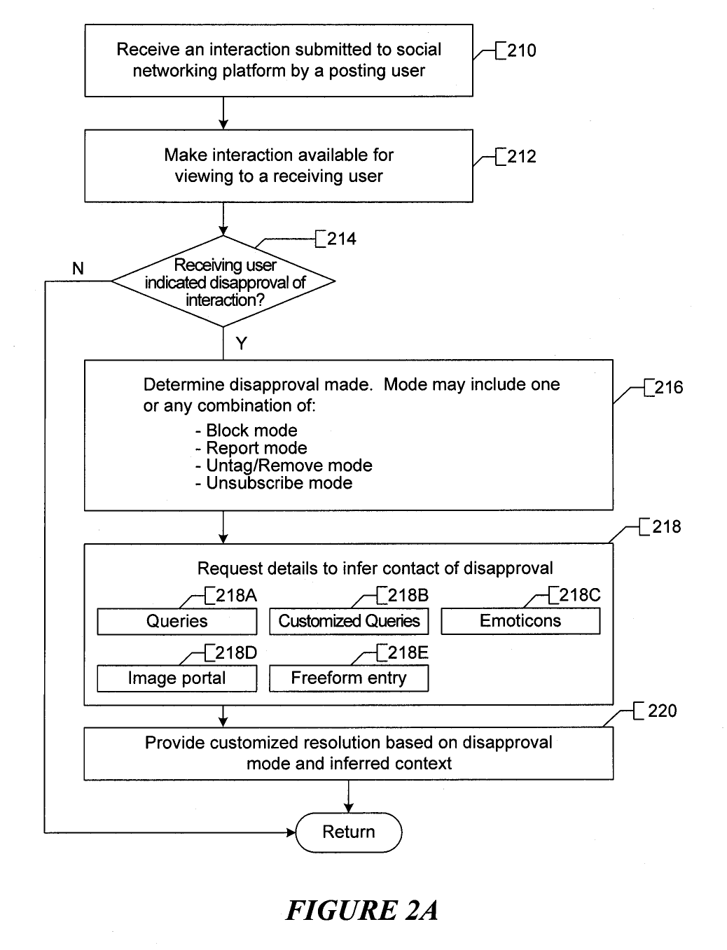

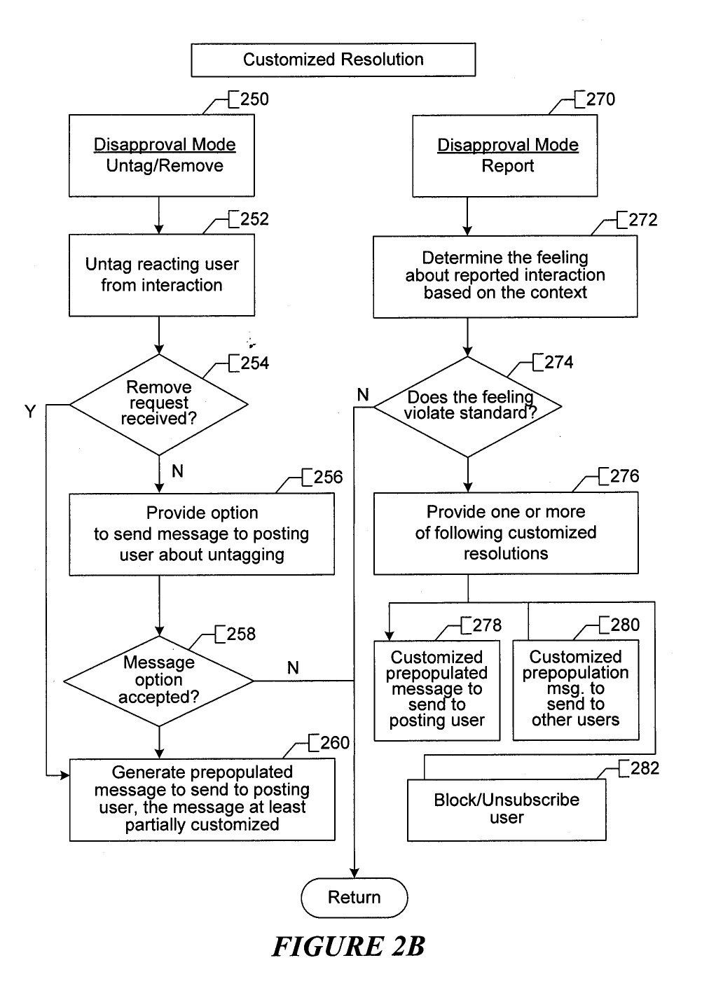

The above description of FIG. 1 provided an exemplary architecture and illustration of an environment in which the various techniques introduced may be practiced. The following sections, with respect to the discussion of FIGS. 2-4, now provide a detailed description of the various customized resolution options introduced in the overview section.

FIG. 2A is a flow diagram depicting a process for providing customized resolution options in response to a receiving user disapproving of an interaction or a message submitted by a posting user. The process begins at step 210, where the networking service receives an interaction submitted by the posting user via the networking server. As discussed above, such an interaction could be, for example, a message posted by the posting user to the receiving user's news wall, or a message posted by the posting user to the posting user's news wall (e.g., as a status update), a message posted by the posting user that associates one of the receiving user's friends (and therefore causing an indication of the interaction to be posted as an update to the receiving user's news wall), etc. Further, as explained above, the message may be textual, indicative of a geo-location, may include one or more images, and may also directly associate (i.e., tag) the receiving user and/or other users of the networking service.

At step 212, the networking service makes this interaction available for viewing to the receiving server. Again, as discussed above, this may be by, for example, causing a message to be posted on the user's news wall indicating that there has been an interaction. In some instances, especially when the receiving user is tagged in the message or is directly targeted to the receiving user, the networking service may also transmit an email or a text message to the user's phone alerting the receiving user of the interaction.

At step 214, the networking service receives an indication of the receiving user's disapproval of the interaction. In an illustrative example, the receiving user may simply click on a suitable option (e.g., a graphic menu providing various actions a user could perform in relation to the interaction) indicating that she would like to object to the interaction. In embodiments, upon receiving such an indication of objection or displeasure, the networking service presents a set of modes or options that the user could choose to pursue a resolution.

As shown in step 216, an example of such modes or options may include a block mode. When the block mode is selected by the receiving user, the posting user will be unable to have any communication with the receiving user via the networking service. For example, the posting user will not be able to message the receiving user or in some cases even be able to determine the presence or membership of the receiving user within the networking service. The receiving user is lost, i.e., blocked to the posting user. Any interactions posted by the blocked user, regardless of whether it pertains to the receiving user or friends of the receiving user, will not be conveyed to the receiving user.

Another option includes a report mode, which enables the receiving user to report the interaction to the networking service as being unacceptable or objectionable. Typically, the report mode will cause the networking service to perform an action to investigate and rectify the situation. Resolution options relating to the reporting mode are explained in further detail below.

Another example of an indication of a disapproval is the use of the untag mode. The untag mode is a request from the receiving user to the networking service to disassociate the receiving user's identity from the posted interaction. A related mode, the remove mode, allows the receiving user to send a message to the posting user, requesting the posting user to remove the interaction from the networking service. A further example, the unsubscribe mode, is less nuclear or stringent in relation to the block mode. The networking service hides any updates from the posting user just to the receiving user, but the receiving user and posting user may still remain “friends” within the networking service and may still retain the option to communicate with each other. Interactions that do not directly concern the receiving user are not communicated to the receiving user (i.e., to the receiving user's news wall).

An advantage of the techniques presented here is in the receiving user's ability to be able to combine (or otherwise customize) the disapproval modes. In the existing art, a user may simply be able to indicate that the user wishes to untag his identity from an interaction or that the user wishes to block another user. However, as presented with the mode options herein, the receiving user may combine several of these modes to improve the effectiveness of resolving issues that are underlying to the objection or displeasure. For example, in addition to indicating that the receiver wishes to be untagged, the receiving user may also indicate that he wishes to send out a message to the posting user to request the posting user to remove the interaction. In another example, the receiving user may further combine a request to report the posting user to the networking service (by choosing the report mode) in addition to the other requests. In embodiments, as will be discussed below, the networking service may itself customize or suggest selection of different mode options based, for example, on a perceived context (e.g., emotional context) associated with the user's disapproval of the interaction.

In embodiments, the networking service also obtains information from the user to be able to analyze context (e.g., emotional context) associated with the user's objection of or displeasure with the posted interaction. In some instances, the networking service provides a user interface, as is indicated in step 218, allowing the user to provide input that is then analyzed to determine the context. It is understood that this interface may be offered in conjunction with the provision of the disapproval modes, or after the user's selection of the disapproval modes, or in some instances, even before the user is offered the disapproval mode options.

In embodiments, the interface may include one or more queries (block 218A) that inquire into the context of the disapproval. For example, in the context of being untagged, the queries may include options such as: Spam? Does not show you in a flattering light? You are not the tagged person? Does this picture make you angry? Is the posting user harassing you? Does this picture make you sad? Similarly, the networking service may present other such queries and the queries may or may not be dependent on the selected disapproval mode options.

In some instances, in addition to or in lieu of the queries, the networking service may present customized queries (block 218B) to the receiving user. The queries may be customized, for example, based on the geographic location of the receiving user by either changing the context of the queries (e.g., Is this picture insensitive to Buddhist culture?) or simply customizing the language or style of questioning. The queries may also be customized based on social context between the two users. For example, if the networking service determines that there has not been any flow of communication between the two users over a period of time and that they do not have sufficient common interests (e.g., common friends, common workplace or school, etc.), the networking service may include a relevant query (e.g., Do you not know this person well?).

In another example, the interface may provide emoticons (block 218C) (e.g., in conjunction with other interface options) that present an easy graphical option that allows the receiving user to indicate her emotional status. In embodiments, for example, the interface may present an option that allows the receiving user to upload an image (photo or video) (block 218D) or capture the image at the moment. Based on analyzing facial features of the receiving user, the networking service may infer context to further customize the queries or simply perceive context based on the facial analysis. In another example, the interface may allow the receiving user to provide freeform text entry (block 218E), and the networking service may infer emotional context based on, for example, semantic analysis of the freeform entry.

In one embodiment, especially where the context interface is provided to the user prior to the disapproval mode selection, the networking service may select a particular combination of the mode options based on an analysis of the emotional context and/or other context. For example, based on analysis of the emotional context and the social context, the networking service determines that the receiving user has been close friends with the posting user for a long time and that the receiving user is angry about the tagged picture. In this case, the networking service, for example, may recommend (or provide as customized resolution options) that the receiving user get the tag removed and further send out a message to the posting user to resolve any differences and further foster effective communication between the parties.

Based on the receipt of the various context situations and the disapproval mode selection or suggestion, the networking service then provides or initiates a customized resolution, as indicated in step 220. Various examples of customized resolution options are now discussed in detail with reference to FIG. 2B.

In a first example of the customized resolution option, as indicated in step 250, the disapproval mode is “untag” and/or “remove interaction” (rather, send message to posting user requesting the interaction be removed). In such a situation, the networking service may untag the receiving user and then initiate a message to be sent to the posting user (as indicated in steps 252 and 254). In some instances, where the user did not specifically ask for the “remove” option, the networking service may still prompt the user to send a message to the user to provide a reasoning behind the untag action. Initiating such communication has proven to increase the chances of a user sending out messages in the context of interaction resolutions, and thus caters towards the networking service's overall goals of improving communication and quality of communication amongst its users.

As indicated in step 256, even if the receiving user does not indicate that he wishes to send a remove request to the posting user, the networking service may still provide an option to send a message to the user (e.g., to indicate to the posting user the reason for the untagging). If the user accepts the option, as indicated in step 258, the networking service provides an interface allowing the receiving user to send the message. In some instances (as indicated in step 260), the message (to be sent to the posting user) may be prepopulated at least in part based on the context (emotional context, social context, etc.). For example, the prepopulated message may include a greeting that resonates with the closeness between the two users (based on the social context) and may include a message that is tuned based on the emotional context or social context.

As an illustrative example, a strongly worded message may be initiated for a more serious allegation (e.g., tagging the receiving user to an image including obscene or pornographic images). The user may also be provided additional information based on the social context (e.g., as a hover window or just an additional window indicating the common interests or friends between the two users) further helping the receiving user edit the existing text with additional information. Providing this prepopulated text or at least the social context to prompt the receiving user to send a message has been proven to be effective in increasing the chances of having the receiving user send a message. In some instances, the message box interface may further provide options to the receiving user to include a video or photo of the receiving user to further customize the message to be sent to the posting user.

A second example of a customized resolution option begins at step 270 of FIG. 2B. Here, the receiving user has opted to report the interaction to the networking service for appropriate action by the networking service. However, given that at least some report requests tend to be an over-reaction to an interaction (based, for example, on personal conflicts or misunderstandings between the two users), the networking service attempts to identify the context between the indication of disapproval in order to promote greater understanding and resolve the conflicts, as indicated in step 272. Based on this, the networking service provides customized resolution solutions, as indicated in step 276, that at least in some aspects offer an alternate solution to the networking service having to take a disciplinary action (especially in a scenario where the posting user has not violated the networking services' standards or norms as indicated in step 274).

Based on an analysis of the social and emotional context information as indicated in step 272, the networking service determines whether there is a good chance of violation of its standards at step 274. For example, if the two users hardly know each other or interact with each other, and the context indicates that the message related to pornography, such an interaction is likely to be analyzed by an administrator of the networking service for further action. If in another example, if the two users happen to have had a substantial amount of interaction within a specified time, are listed as family members, and the context indicates that the message causes the receiving user to be sad, then the conflict resolution mechanism may simply prompt the receiving user to send a message to the posting user (step 278).

In some examples, if the conflict is determined to be of a certain level but does not rise to be a violation of the networking service's standard, the networking service may offer other customized resolutions, as indicated in step 276. Such resolutions may include, for example, sending customized messages to the posting user (step 278), or putting the receiving user in touch with other users that have experienced similar issues to obtain support from such users (step 280), and/or blocking or unsubscribing the posting user (step 282).

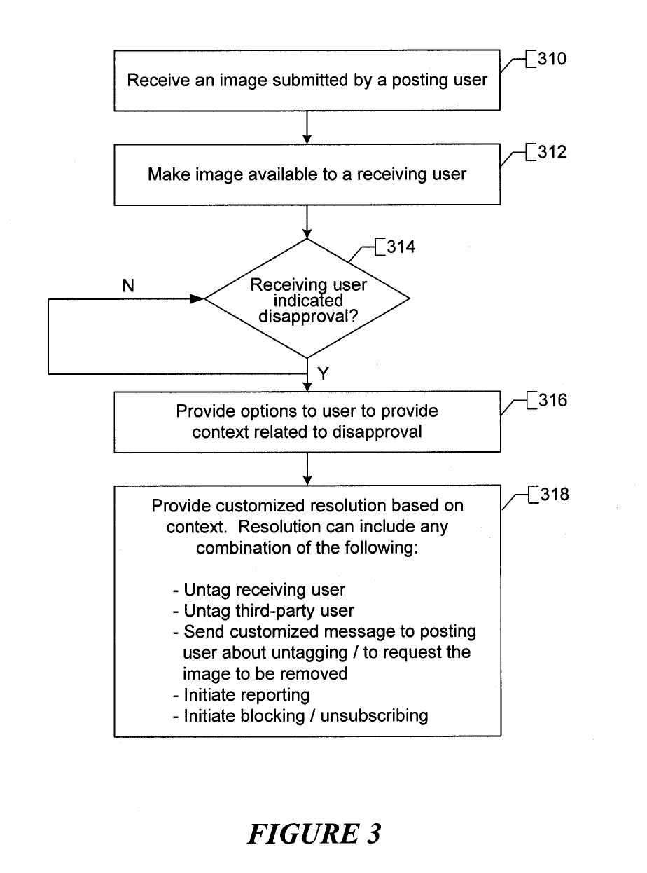

FIGS. 2A and 2B presented various customized resolution option mechanisms offered by the networking service in relation to any interaction initiated by a posting user. FIG. 3 now depicts a process that focuses on customized resolution options provided specifically in a situation where a receiving user wishes to untag his identity from an image or other such message. In some instances, this exemplary process may also apply to a situation where the receiving user is not tagged, but a friend of the receiving user (a “third-party user”) is tagged and the receiving user objects to that tagging. The process starts with steps 310 and 312, with the receiving user receiving an indication that the posting user has submitted an image via the networking service and that the image specifically associates the receiving user (i.e., the receiving user is tagged in the image).

If the networking service receives an indication from the receiving user of her disapproval of the posted image, as indicated in step 314, the process moves to step 316. Here, the user is provided with options that relate to the context of disapproval. Here, as discussed above with respect to FIG. 2A, the context may be gathered using a context interface (using, e.g., queries, customized queries, emoticons, etc.). The networking service may further determine context based on the social context between the two users, as also discussed in detail above with respect to FIG. 2A. Based on the analyzed context, as indicated in step 318, the networking service may present one or a combination of customized resolution options. In the exemplary illustration of FIG. 3, such customized resolution options may include any combination of the following: untag the receiving user, untag the third-party user, send a customized message to the posting user (about the untagging, to remove the image from the networking service, etc.), initiate reporting to the networking service, or initiate blocking or unsubscribing the posting user. The customization may be, for example, in providing the user a selected subset of the resolution options, providing the options in a given order, and/or prepopulating text in message boxes.

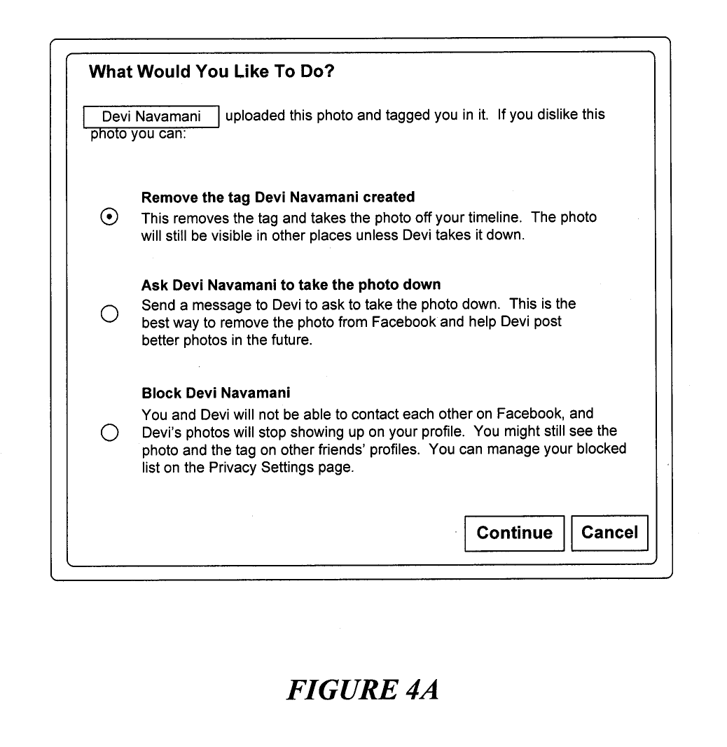

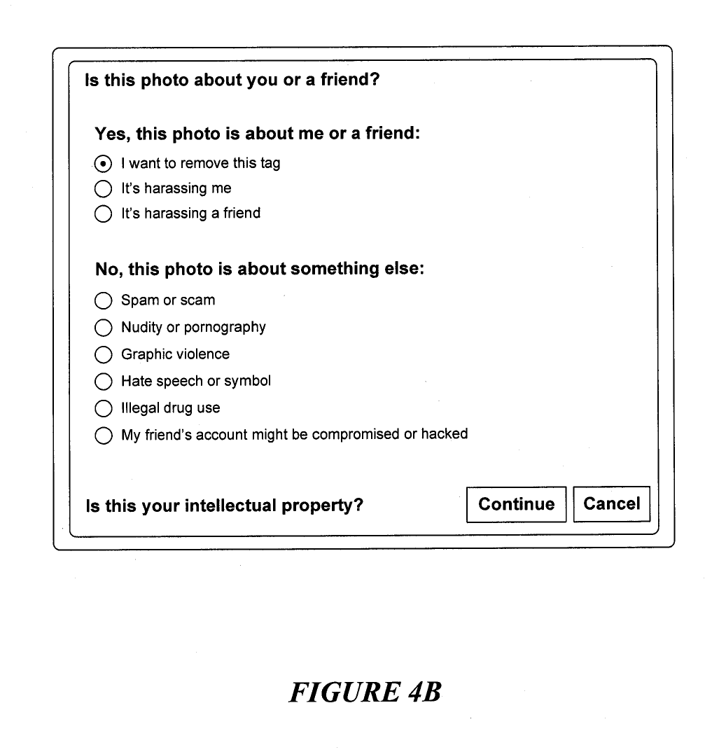

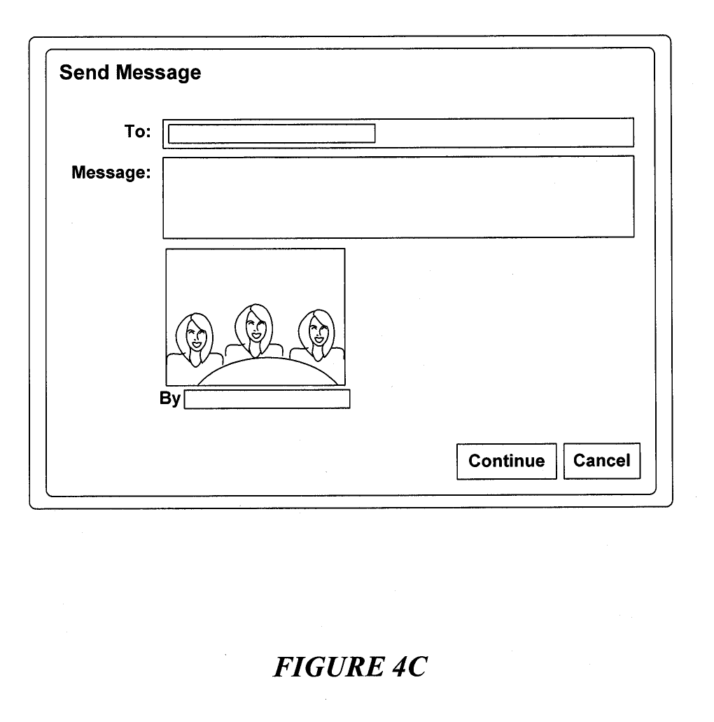

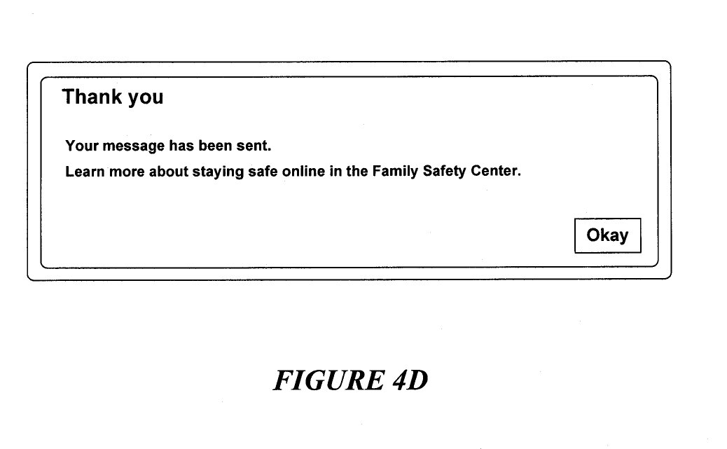

FIGS. 4A to 4D are screenshots that illustrate an exemplary functioning of the customized resolution process described herein. This exemplary illustration applies to a situation where a receiving user expresses displeasure over a picture in which she is tagged. The interface illustrated in FIG. 4A is displayed when the receiving user indicates her displeasure in having been tagged in a picture posted by the posting user. The interface presented in FIG. 4A provides multiple “mode” options (as referred to in FIG. 2A), including: remove the tag created by the posting user, send a message to the posting user to have the photo taken down, and block the posting user. As discussed above.

Based on the user's selection of one of the mode options, the networking service provides an interface to obtain context relating to the user's objection to the image. In this exemplary illustration, based on the user indicating that the tag needs to be removed, the networking service obtains additional input relating to the context behind the user's objection. In this example, the networking service inquires on the basis of the user's objection to the image. Based on the input, the networking service may identify multiple resolution options, as explained in detail in reference to FIGS. 2A and 2B above.

In this exemplary illustration, the networking service removes the tag and initiates a message to be sent to the posting user. An example of such a message interface is shown in FIG. 4C. As shown in FIG. 4C, the message box is left blank, but as discussed above in reference to FIG. 2B, the message box may be at least partly prepopulated with text based on the emotional context (observed based on the user input) and/or social context (based on the social connection between the two users). In this example of FIG. 4C, the message includes a thumbnail version of the image the receiving user objected to, in an effort to provide message context to both users. As explained above, in at least some embodiments, additional information related to the social context of the two users may be prompted to the user to help the user draft a contextual message. Upon transmission of the message, a confirmation is provided to the receiving user, as illustrated in FIG. 4D.

The above description provided detailed description on examples of customized resolution options a networking service could offer a user based on the user's objection to or displeasure with an interaction posted via the networking service. As explained above, such customized resolution options operate to improve the efficiency and substance of communication among users, present opportunities for promoting greater understanding and resolving conflicts, and ensure more efficient processes allowing a user to report abuse or objection to posted materials to the networking service.

### Exemplary System Architecture

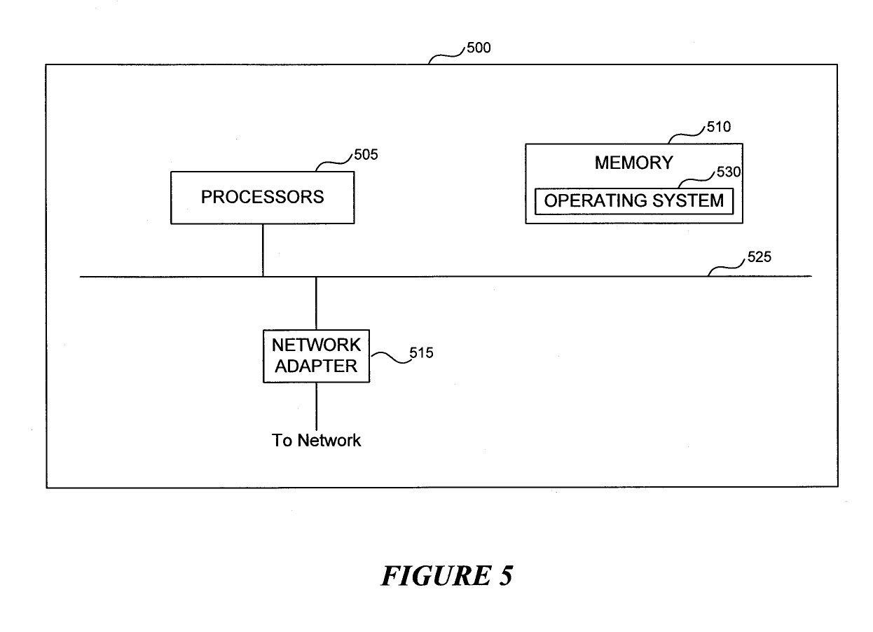

FIG. 5 is a high-level block diagram showing an example of the architecture for a computer system 500 that can be utilized to implement a platform server (e.g., 114 from FIG. 1), a web server (e.g., 125 from FIG. 1), etc. In FIG. 5, the computer system 500 includes one or more processors 505 and memory 510 connected via an interconnect 525. The interconnect 525 is an abstraction that represents any one or more separate physical buses, point to point connections, or both connected by appropriate bridges, adapters, or controllers. The interconnect 525, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 594 bus, sometimes referred to as “Firewire”.

The processor(s) 505 may include central processing units (CPUs) to control the overall operation of, for example, the host computer. In certain embodiments, the processor(s) 505 accomplish this by executing software or firmware stored in memory 510. The processor(s) 505 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 510 is or includes the main memory of the computer system 1100. The memory 510 represents any form of random access memory (RAM), read-only memory (ROM), flash memory (as discussed above), or the like, or a combination of such devices. In use, the memory 510 may contain, among other things, a set of machine instructions which, when executed by processor 505, causes the processor 505 to perform operations to implement embodiments of the present invention.

Also connected to the processor(s) 505 through the interconnect 525 is a network adapter 515. The network adapter 515 provides the computer system 500 with the ability to communicate with remote devices, such as the storage clients, and/or other storage servers, and may be, for example, an Ethernet adapter or Fiber Channel adapter

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method of processing interactions in a social networking platform, the method comprising:
providing, by the social networking platform, an indication of an interaction to a receiving user of the social networking platform, the interaction submitted via the social networking platform by a posting user;
receiving, from the receiving user, an indication of disapproval of the interaction submitted by the posting user;
identifying, by the social networking platform, emotional context associated with the receiving user's disapproval of the interaction; and
in response to receiving the indication of disapproval, providing, to the receiving user, a resolution option that is customized at least in part based on the emotional context received from the user.

2. The method of claim 1, wherein the indication of disapproval received from the receiving user is one or more of:
an untag request to disassociate the receiving user's identify from the submitted interaction;
a report request to initiate reporting of the disapproval to a provider of the social networking platform;
an unsubscribe request to request the provider to withhold, with respect to the receiving user, at least a part of information submitted by the posting user; or
a block request to request the provider to block at least a part of communication or interaction between the posting user and the receiving user.

3. The method of claim 1, wherein identifying the emotional context associated with the receiving user includes:
providing an interface allowing the user to express an emotional state.

4. The method of claim 3, wherein the interface is one or more of:
a plurality of queries related to the receiving user's emotional state, the interface accepting a response to one or more of the queries;
a plurality of emoticons indicative of emotional states, the interface accepting the receiving user's selection of one or more of the plurality of emoticons;
an image portal, the interface accepting a still or video image of the receiving user for determining an emotional context associated with the receiving user based at least in part on analyzing the submitted image; or
a freeform entry portal, the interface accepting freeform text entered by the user for determining an emotional context associated with the receiving user based on a semantic analysis of the submitted freeform text.

5. The method of claim 4, wherein at least a portion of the plurality of queries or the plurality of emoticons are identified for placement in the interface based on one or more of:
a social context indicative of common interests or activities associated with the receiving user and the posting user; or
an environmental context based at least in part on a geographic, cultural, and/or religional context associated with the receiving user and/or the posting user.

6. The method of claim 2, wherein the customized resolution includes:
in conjunction with receipt of the untag request from the receiving user, providing the receiving user an option to transmit a response message to the posting user, the response message being at least partly prepopulated with message content based at least in part on the identified emotional context.

7. The method of claim 6, wherein, in conjunction with the response message option, the social networking platform further provides one or more of:
a social similarity portal to provide information based at least in part on similarities in profiles associated with the receiving user and the posting user, the information provided to provide additional context for the receiving user to customize the prepopulated response message;
an image upload portal enabling the user to capture and upload a still or a video image to be submitted in conjunction with the prepopulated response message;
an environmental adjustment feature that customizes the prepopulated response message based at least in part on a geographic, cultural, and/or religional context associated with the receiving user and/or the posting user.

8. The method of claim 2, wherein the customized resolution includes:
in conjunction with receipt of the report request from the receiving user, performing one or more of:
providing the receiving user an option to transmit a response message to the posting user, the response message being at least partly prepopulated with message content based at least in part on the identified emotional context; or
providing, to the receiving user, information associated with other users of the social networking platform who had previously submitted report requests, the other users having been identified as having similar emotional context at the time of their submission of their report requests.

9. The method of claim 8, further comprising:
determining whether the submitted interaction is in violation of policies set by the provider based at least in part on the identified emotional context;
responding, by the social networking platform, to the report request based at least in part on the determination of the violation.

10. The method of claim 8, wherein, in conjunction with the response message option, the social networking platform further provides one or more of:
a social similarity portal to provide information based at least in part on similarities in profiles associated with the receiving user and the posting user, the information provided to provide additional context for the receiving user to customize the prepopulated response message;
an image upload portal enabling the user to capture and upload a still or a video image to be submitted in conjunction with the prepopulated response message;
an environmental adjustment feature that customizes the prepopulated response message based at least in part on a geographic, cultural, and/or religional context associated with the receiving user and/or the posting user.

11. The method of claim 1, wherein the interaction is one or more of:
a still or video image posted by the posting user;
a textual posting posted by the posting user;
a news item posted by the posting user;
a blog article posted by the posting user; or
a geo-locational mapping posted by the posting user.

12. A method of processing interactions in a social networking platform, the method comprising:
providing, by the social networking platform, an indication to a receiving user that an image has been submitted, the image submitted via the social networking platform and/or tagged by a posting user;
receiving, from the receiving user, an indication of disapproval relating to the submitted image;
receiving, from the receiving user, context associated with the user's disapproval of the submitted image; and
in response to receiving the indication of disapproval, providing, to the receiving user, one or more resolution options associated with actions to be taken in response to the user's indication of disapproval, the one or more options chosen at least in part on the context received from the receiving user.

13. The method of claim 12, wherein the indication of disapproval includes the receiving user's selection of one or more disapproval options presented to the receiving user in conjunction with the submitted image, the selection of the one or more disapproval options prompting the social networking platform to receive the context from the receiving user.

14. The method of claim 12, wherein the social networking platform provides a plurality of context options to request the user to provide the context, the plurality of context options including one or more of:
an owner untag option that would enable the receiving user to disassociate the receiving user's identify from the submitted image;
a third-party untag request that would enable the receiving user to dissociate, from the submitted image, an identify of the third-party tagged in the image, the third-party having a social connection in the social networking platform to the receiving user;
one or more emotional context options that are indicative of the receiving user's emotion or justification for expressing the indication of disapproval of the submitted image.

15. The method of claim 14, wherein the one or more emotional context options are presented to the user using an interface, the interface including one or more of:
a plurality of queries related to the receiving user's emotional state or feeling, the interface accepting a response to one or more of the queries;
a plurality of emoticons indicative of emotional states, the interface accepting the receiving user's selection of one or more of the plurality of emoticons;
an image portal, the interface accepting a still or video image of the receiving user for determining an emotional context associated with the receiving user based at least in part on analyzing the submitted image; or
a freeform entry portal, the interface accepting freeform text entered by the user for determining an emotional context associated with the receiving user based on a semantic analysis of the submitted freeform text.

16. The method of claim 14, wherein each of the one or more of resolution options provided to the receiving user include:
an untagging resolution option that would untag the receiving user or the third-party with respect to the submitted image;
a messaging resolution option that would initiate a message to be sent to the posting user to request the posting user to perform an action with respect to the submitted image;
a blocking resolution option that would cause social communication to be blocked between the receiving user and the posting user; or
a reporting resolution option that would initiate a message to be sent to the social networking platform in relation to the receiving user's disapproval, the message at least partially including the context received from the user.

17. The method of claim 16, wherein in conjunction with receipt of the receiving user's choice of the untagging resolution option, the blocking resolution option, or the reporting resolution option:
providing the receiving user an option to transmit a response message to the posting user, the response message being at least partly prepopulated with message content based at least in part on the context received from the receiving user.

18. The method of claim 17, wherein, in conjunction with the response message option, the social networking platform further provides one or more of:
a social similarity portal to provide information based at least in part on similarities in profiles associated with the receiving user and the posting user, the information provided to provide additional context for the receiving user to customize the prepopulated response message;
an image upload portal enabling the user to capture and upload a still or a video image to be submitted in conjunction with the prepopulated response message;
an environmental adjustment feature that customizes the prepopulated response message based at least in part on a geographic, cultural, and/or religional context associated with the receiving user and/or the posting user.

19. The method of claim 16, wherein in conjunction with receipt of the receiving user's choice of the messaging resolution option:
providing the receiving user an interface to transmit a response message to the posting user requesting the user to remove the submitted image, the response message being at least partly prepopulated with message content based at least in part on the context received from the receiving user.

20. The method of claim 19, wherein, in conjunction with the response message interface provided to the receiving user, the social networking platform further provides one or more of:
a social similarity portal to provide information based at least in part on similarities in profiles associated with the receiving user and the posting user, the information provided to provide additional context for the receiving user to customize the prepopulated response message;
an image upload portal enabling the user to capture and upload a still or a video image to be submitted in conjunction with the prepopulated response message;
an environmental adjustment feature that customizes the prepopulated response message based at least in part on a geographic, cultural, and/or religional context associated with the receiving user and/or the posting user.

21. A system, comprising:
at least one memory storing computer-executable instructions; and
at least one processor configured to access the at least one memory and execute the computer-executable instructions to perform a set of operations, the operations including:
providing, by the social networking platform, an indication of an interaction to a receiving user of the social networking platform, the interaction submitted via the social networking platform by a posting user;
receiving, from the receiving user, an indication of disapproval of the interaction submitted by the posting user;
identifying, by the social networking platform, emotional context associated with the receiving user's disapproval of the interaction; and
in response to receiving the indication of disapproval, providing, to the receiving user, a resolution option that is customized at least in part based on the emotional context received from the user.

22. The system of claim 21, wherein the indication of disapproval received from the receiving user is one or more of:
an untag request to disassociate the receiving user's identify from the submitted interaction;
a report request to initiate reporting of the disapproval to a provider of the social networking platform;
an unsubscribe request to request the provider to withhold, with respect to the receiving user, at least a part of information submitted by the posting user; or
a block request to request the provider to block at least a part of communication or interaction between the posting user and the receiving user.

23. The system of claim 21, wherein identifying the emotional context associated with the receiving user includes:
providing an interface allowing the user to express an emotional state.

24. The system of claim 23, wherein the interface is one or more of:
a plurality of queries related to the receiving user's emotional state, the interface accepting a response to one or more of the queries;
a plurality of emoticons indicative of emotional states, the interface accepting the receiving user's selection of one or more of the plurality of emoticons;
an image portal, the interface accepting a still or video image of the receiving user for determining an emotional context associated with the receiving user based at least in part on analyzing the submitted image; or
a freeform entry portal, the interface accepting freeform text entered by the user for determining an emotional context associated with the receiving user based on a semantic analysis of the submitted freeform text.

25. The system of claim 24, wherein at least a portion of the plurality of queries or the plurality of emoticons are identified for placement in the interface based on one or more of:
a social context indicative of common interests or activities associated with the receiving user and the posting user; or
an environmental context based at least in part on a geographic, cultural, and/or religional context associated with the receiving user and/or the posting user.

26. The system of claim 22, wherein the customized resolution includes:
in conjunction with receipt of the untag request from the receiving user, providing the receiving user an option to transmit a response message to the posting user, the response message being at least partly prepopulated with message content based at least in part on the identified emotional context.

27. The system of claim 26, wherein, in conjunction with the response message option, the social networking platform further provides one or more of:
a social similarity portal to provide information based at least in part on similarities in profiles associated with the receiving user and the posting user, the information provided to provide additional context for the receiving user to customize the prepopulated response message;
an image upload portal enabling the user to capture and upload a still or a video image to be submitted in conjunction with the prepopulated response message;
an environmental adjustment feature that customizes the prepopulated response message based at least in part on a geographic, cultural, and/or religional context associated with the receiving user and/or the posting user.

28. The system of claim 22, wherein the customized resolution includes:
in conjunction with receipt of the report request from the receiving user, performing one or more of:
providing the receiving user an option to transmit a response message to the posting user, the response message being at least partly prepopulated with message content based at least in part on the identified emotional context; or
providing, to the receiving user, information associated with other users of the social networking platform who had previously submitted report requests, the other users having been identified as having similar emotional context at the time of their submission of their report requests.

29. The system of claim 28, wherein the set of operations further comprises:
determining whether the submitted interaction is in violation of policies set by the provider based at least in part on the identified emotional context;
responding, by the social networking platform, to the report request based at least in part on the determination of the violation.

30. One or more computer-readable media storing computer-executable instructions that, when executed by at least one processor, configure the at least one processor to perform operations corresponding to a method for monitoring domains, the method comprising:
providing, by the social networking platform, an indication to a receiving user that an image has been submitted, the image submitted via the social networking platform and/or tagged by a posting user;
receiving, from the receiving user, an indication of disapproval relating to the submitted image;
receiving, from the receiving user, context associated with the user's disapproval of the submitted image; and
in response to receiving the indication of disapproval, providing, to the receiving user, one or more resolution options associated with actions to be taken in response to the user's indication of disapproval, the one or more options chosen at least in part on the context received from the receiving user.

31. The one or more computer-readable media of claim 30, wherein the indication of disapproval includes the receiving user's selection of one or more disapproval options presented to the receiving user in conjunction with the submitted image, the selection of the one or more disapproval options prompting the social networking platform to receive the context from the receiving user.

32. The one or more computer-readable media of claim 30, wherein the social networking platform provides a plurality of context options to request the user to provide the context, the plurality of context options including one or more of:
an owner untag option that would enable the receiving user to disassociate the receiving user's identify from the submitted image;
a third-party untag request that would enable the receiving user to dissociate, from the submitted image, an identify of the third-party tagged in the image, the third-party having a social connection in the social networking platform to the receiving user;
one or more emotional context options that are indicative of the receiving user's emotion or justification for expressing the indication of disapproval of the submitted image.

33. The one or more computer-readable media of claim 32, wherein the one or more emotional context options are presented to the user using an interface, the interface including one or more of:
a plurality of queries related to the receiving user's emotional state or feeling, the interface accepting a response to one or more of the queries;
a plurality of emoticons indicative of emotional states, the interface accepting the receiving user's selection of one or more of the plurality of emoticons;
an image portal, the interface accepting a still or video image of the receiving user for determining an emotional context associated with the receiving user based at least in part on analyzing the submitted image; or
a freeform entry portal, the interface accepting freeform text entered by the user for determining an emotional context associated with the receiving user based on a semantic analysis of the submitted freeform text.

34. The one or more computer-readable media of claim 32, wherein each of the one or more of resolution options provided to the receiving user include:
an untagging resolution option that would untag the receiving user or the third-party with respect to the submitted image;
a messaging resolution option that would initiate a message to be sent to the posting user to request the posting user to perform an action with respect to the submitted image;
a blocking resolution option that would cause social communication to be blocked between the receiving user and the posting user; or
a reporting resolution option that would initiate a message to be sent to the social networking platform in relation to the receiving user's disapproval, the message at least partially including the context received from the user.

35. The one or more computer-readable media of claim 34, wherein in conjunction with receipt of the receiving user's choice of the untagging resolution option, the blocking resolution option, or the reporting resolution option:
providing the receiving user an option to transmit a response message to the posting user, the response message being at least partly prepopulated with message content based at least in part on the context received from the receiving user.

36. The one or more computer-readable media of claim 34, wherein in conjunction with receipt of the receiving user's choice of the messaging resolution option:
providing the receiving user an interface to transmit a response message to the posting user requesting the user to remove the submitted image, the response message being at least partly prepopulated with message content based at least in part on the context received from the receiving user.
